(19) United States
(12) Patent Application Publication
(10) Pub. No.: US 2025/0138274 A1
(43) Pub. Date: May 1, 2025

(54) VIBRATION-TYPE ACTUATOR AND ELECTRONIC APPARATUS

(71) Applicant: CANON KABUSHIKI KAISHA, Tokyo (JP)

(72) Inventors: YU TAKAHASHI, Kanagawa (JP); Atsushi Kimura, Chiba (JP); MASAAKI UDAGAWA, Ibaraki (JP); MAKOTO NISHINO, Kanagawa (JP)

(21) Appl. No.: 19/009,472

(22) Filed: Jan. 3, 2025

Related U.S. Application Data
(63) Continuation of application No. PCT/JP2023/023256, filed on Jun. 23, 2023.

(30) Foreign Application Priority Data
Jul. 15, 2022 (JP) 2022-113922

(51) Int. Cl. G02B 7/04; G03B 13/34

(52) U.S. Cl. CPC G02B 7/04; G03B 13/34

(57) ABSTRACT

A vibration-type actuator includes a vibrator including an electro-mechanical energy conversion element and an elastic member, and a contact member. The elastic member includes a rectangular plate portion along the first direction, a protruding portion protruding in a second direction crossing the first direction, and an extending portion extending from the plate portion in a direction along the first direction. The vibration-type actuator further includes a support member to be brought into contact with at least one of the extending portion and the plate portion to support the vibrator movably along the second direction. A part of the elastic member is provided with a contact surface and an inclined portion, the contact surface being in contact with the support member along the second direction, the inclined portion being adjacent to the contact surface and being inclined in a direction away from the support member relative to the contact surface.

### CROSS-REFERENCE TO RELATED APPLICATIONS

This application is a Continuation of International Patent Application No. PCT/JP2023/023256, filed Jun. 23, 2023, which claims the benefit of Japanese Patent Application No. 2022-113922, filed Jul. 15, 2022, both of which are hereby incorporated by reference herein in their entirety.

### BACKGROUND OF THE DISCLOSURE

### Field of the Disclosure

The present disclosure relates to a vibration-type actuator and an electronic apparatus.

### Background Art

Various configurations of vibration-type actuators using an electro-mechanical energy conversion element are known. For example, a vibration-type actuator that drives a vibrator having a configuration in which an electro-mechanical energy conversion element is bonded to an elastic member (hereinafter referred to as a vibrating plate) having two protrusions by bringing the vibrator into pressure contact with a driven member is known.

This vibration-type actuator applies a predetermined alternating-current voltage to the electro-mechanical energy conversion element, thereby generating an elliptical motion or a circular motion at leading edges of two protrusions within a plane including a direction connecting the two protrusions and the protruding direction of the protrusions. With this configuration, when the driven member receives a frictional driving force from the two protrusions, the vibrator and the driven member can be relatively moved in the direction connecting the two protrusions.

A vibration-type actuator discussed in Patent Literature 1 has a configuration in which end faces of a rectangular portion and an extending portion of a vibrating plate are brought into contact with and loosely fitted to a plurality of protruding portions provided on a support member, thereby holding the vibrator. With this configuration, size reduction in a motor driving direction and reduction in the risk of generation of abnormal sound can be achieved.

Further, a vibration-type actuator discussed in Patent Literature 2 is focused on a method of bonding a vibrating plate and an electro-mechanical energy conversion element and is designed to reduce a processing time for a polishing process and improve the shape accuracy after polishing of the vibrating plate by defining the direction of a burr generated in press molding.

Meanwhile, there is a recent demand for applying a vibration-type actuator for various applications, and there is an issue to further enhance the stability of the driving speed of the vibration-type actuator itself.

### CITATION LIST

### Patent Literature

PTL 1: Japanese Patent Laid-Open No. 2020-198658
PTL 2: Japanese Patent Laid-Open No. 2015-43670

### SUMMARY OF THE DISCLOSURE

The present disclosure has been made to solve the above-described issue, and is directed to providing a vibration-type actuator capable of performing a driving operation at a stable speed.

To solve the above-described problem, a vibration-type actuator according to the present disclosure includes a vibrator including an electro-mechanical energy conversion element and an elastic member, and a contact member to be bought into contact with the elastic member, vibration of the vibrator allowing the contact member and the vibrator to relatively move in a first direction, wherein the elastic member includes a rectangular plate portion along the first direction, a protruding portion protruding in a second direction crossing the first direction, and an extending portion extending from the plate portion in a direction along the first direction, wherein the vibration-type actuator further comprises a support member to be brought into contact with at least one of the extending portion and the plate portion to support the vibrator movably along the second direction, and wherein a part of the elastic member is provided with a contact surface and an inclined portion, the contact surface being in contact with the support member along the second direction, the inclined portion being adjacent to the contact surface and being inclined in a direction away from the support member relative to the contact surface.

Further features of the present disclosure will become apparent from the following description of exemplary embodiments with reference to the attached drawings.

### BRIEF DESCRIPTION OF THE DRAWINGS

FIG. 1 is an assembled perspective view of a vibration-type actuator according to a first exemplary embodiment of the present disclosure.

FIG. 2 is an exploded perspective view of the vibration-type actuator according to the first exemplary embodiment of the present disclosure.

FIG. 3A illustrates vibration modes according to the first exemplary embodiment of the present disclosure.

FIG. 3B illustrates vibration modes according to the first exemplary embodiment of the present disclosure.

FIG. 4 is an assembled perspective view illustrating a vibrator and a support member according to the first exemplary embodiment of the present disclosure.

FIG. 5A is an assembled plan view illustrating the vibrator and the support member according to the first exemplary embodiment of the present disclosure.

FIG. 5B is an assembled plan view illustrating the vibrator and the support member according to the first exemplary embodiment of the present disclosure.

FIG. 6 is an assembled plan view of the vibrator and a piezoelectric element bonding/positioning component according to the first exemplary embodiment of the present disclosure.

FIG. 7A is a sectional view illustrating a side surface that contacts a support member of an elastic member according to the first exemplary embodiment of the present disclosure.

FIG. 7B is a sectional view illustrating a side surface that contacts a support member of an elastic member according to the first exemplary embodiment of the present disclosure.

FIG. 8 is a sectional view illustrating a side surface that contacts a support member of an elastic member according to a second exemplary embodiment of the present disclosure.

FIG. 9 is an exploded perspective view of a vibration-type actuator according to a third exemplary embodiment of the present disclosure.

FIG. 10 is a sectional view of the vibration-type actuator according to the third exemplary embodiment of the present disclosure.

FIG. 11A is a top view illustrating a schematic configuration of an image capturing apparatus including a vibration-type actuator according to an exemplary embodiment of the present disclosure.

FIG. 11B is a block diagram illustrating a schematic configuration of the image capturing apparatus including the vibration-type actuator according to the exemplary embodiment of the present disclosure.

FIG. 12A illustrates a top dead center state of shearing processing in press molding according to a fifth exemplary embodiment of the present disclosure.

FIG. 12B illustrates a bottom dead center state of shearing processing in press molding according to the fifth exemplary embodiment of the present disclosure.

FIG. 12C is an enlarged view of a shearing portion to be subjected to shearing processing in press molding according to the fifth exemplary embodiment of the present disclosure.

FIG. 13A is a top view illustrating a process of trimming an elastic member according to the fifth exemplary embodiment of the present disclosure.

FIG. 13B is a top enlarged view of an extending portion in the process of trimming the elastic member according to the fifth exemplary embodiment of the present disclosure.

FIG. 14 is a side view illustrating an end face shape of the elastic member according to the fifth exemplary embodiment of the present disclosure.

FIG. 15A is an enlarged view illustrating a state of a burr in a contact portion between the elastic member and a support member according to the fifth exemplary embodiment of the present disclosure.

FIG. 15B is an enlarged view illustrating a state of a crushed burr in the contact portion between the elastic member and the support member according to the fifth exemplary embodiment of the present disclosure.

FIG. 16A illustrates a top dead center state of burr crushing processing in press molding according to the fifth exemplary embodiment of the present disclosure.

FIG. 16B illustrates a halfway state of burr crushing processing in press molding according to the fifth exemplary embodiment of the present disclosure.

FIG. 16C illustrates a bottom dead center state of burr crushing processing in press molding according to the fifth exemplary embodiment of the present disclosure.

FIG. 17 is an enlarged view illustrating an inclined surface of the elastic member according to the fifth exemplary embodiment of the present disclosure.

FIG. 18A is an enlarged view illustrating secondary shearing on a contact surface between the elastic member and the support member according to the fifth exemplary embodiment of the present disclosure.

FIG. 18B is an enlarged view of an inclined surface of the contact surface between the elastic member and the support member according to the fifth exemplary embodiment of the present disclosure.

### DESCRIPTION OF THE EMBODIMENTS

A vibration-type actuator according to the present disclosure for solving the above-described issue includes a vibrator including an electro-mechanical energy conversion element and an elastic member, and a contact member to be bought into contact with the elastic member. In the vibration-type actuator, vibration of the vibrator allows the contact member and the vibrator to relatively move in a first direction.

The elastic member includes a rectangular plate portion along the first direction, a protruding portion protruding in a second direction crossing the first direction, and an extending portion extending from the plate portion in a direction along the first direction.

The vibration-type actuator further includes a support member to be brought into contact with at least one of the extending portion and the plate portion to support the vibrator movably along the second direction. A part of the elastic member is provided with a contact surface that is in contact with the support member along the second direction, and with an inclined portion that is adjacent to the contact surface and is inclined in a direction away from the support member relative to the contact surface.

An end face of the elastic member is provided with a vertical surface and an inclined surface, which reduce the possibility and degree of interference of a burr of the elastic member, which may be crushed in a pressing process or may be caused to protrude due to driving of the actuator, with the support member.

It can also be expected that a leading edge of the extending portion used for positioning in the process of bonding the electro-mechanical energy conversion element to the elastic member is prevented from interfering with an elastic member positioning jig even when the burr of the elastic member is crushed in the pressing process.

Examples of the vibration-type actuator may include a vibration-type actuator that linearly drives a common contact member by a plurality of vibrators, and a vibration-type actuator that rotationally drives a common contact member by a plurality of vibrators located on a circumference.

Further stabilizing a driving speed can be expected by reducing a frictional resistance due to the interference between the support member and a vibrating plate by forming an edge portion of the vibrating plate in an appropriate shape and changing conditions for the contact between the support member and the vibrating plate in the support configuration of the vibrator. Exemplary embodiments of the present disclosure will be described in detail below with reference to the drawings.

### First Exemplary Embodiment

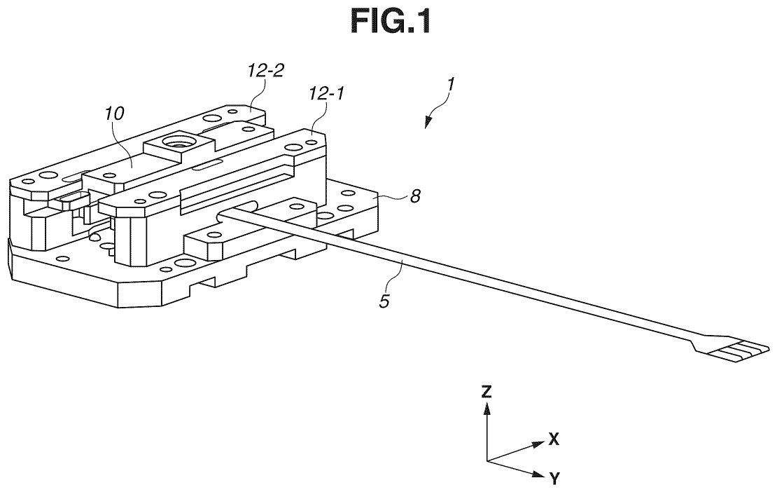

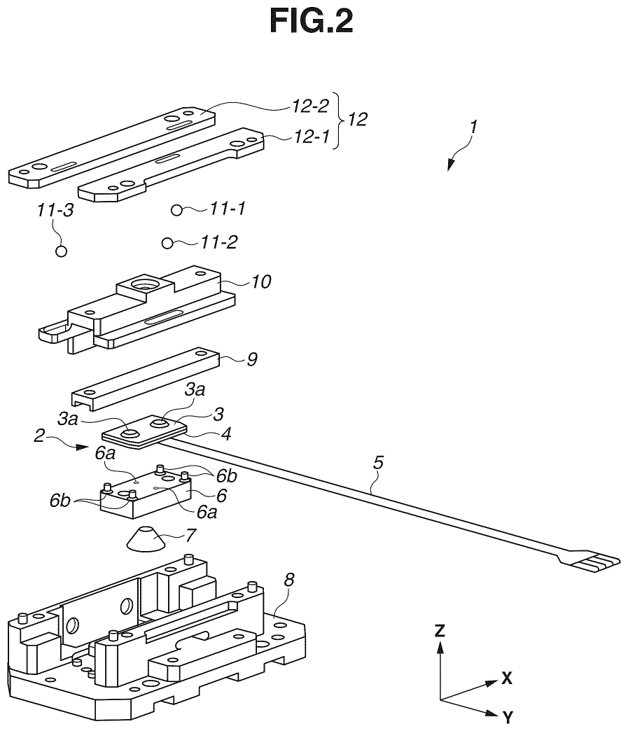

The first exemplary embodiment is an example where the present disclosure is applied to a linear vibration-type actuator that performs a linear driving operation. FIGS. 1 to 7B illustrate details of the linear vibration-type actuator. FIG. 1 is an assembled perspective view of a vibration-type actuator 1 according to the first exemplary embodiment of the present disclosure. FIG. 2 is an exploded perspective view of the vibration-type actuator 1. A movement direction of a slider 9 serving as a contact member is defined as an X-direction, a pressurizing direction is defined as a Z-direction, and a direction perpendicular to the Z-direction is defined as a Y-direction.

The term “contact member” refers to a member that is brought into contact with a vibrating body and moves relative to the vibrating body due to the vibration generated in the vibrating body. The contact between the contact member and the vibrating body is not limited to direct contact without any other member interposed between the contact member and the vibrating body. The contact between the contact member and the vibrating body may be indirect contact with any other member interposed between the contact member and the vibrating body, as long as the contact member can move relative to the vibrating body due to the vibration generated in the vibrating body. The term “any other member” is not limited to a member (e.g., a high-friction member made of a sintered body) independent of the contact member and the vibrating body. The term “any other member” may include a surface-treated portion of the contact member or the vibrating body that is formed by plating, nitriding treatment, or the like.

An elastic member 3 and a piezoelectric element 4 serving as an electro-mechanical energy conversion element are fixed with an adhesive or the like. Further, a flexible printed circuit board 5 is fixed to the piezoelectric element 4 on an an opposite surface of the elastic member 3. These components constitute a vibrator 2. The flexible printed circuit board 5 is fixed with an anisotropic conductive paste or an anisotropic conductive film, which enables energization only in the Z-direction.

The elastic member is composed of a substantially rectangular plate portion, one or more protruding portions protruding from the plate portion toward an outside of a flat surface forming the plate portion, i.e., protruding in a direction crossing a movement direction, and one or more extending portions extending in a direction along the flat surface from the plate portion, i.e., along the movement direction.

The movement direction is defined as a first direction, and the direction crossing the movement direction is defined as a second direction.

The elastic member 3 is preferably made of a material causing small attenuation of vibration, such as a metal or ceramics. In manufacture of the elastic member 3, protruding portions 3a may be integrally formed by press molding, cutting, or the like, or the protruding portions 3a may be separately manufactured and fixed later by welding, adhesion, or the like. A plurality of protruding portions 3a may be provided like in the present exemplary embodiment, or one protruding portion 3a may be provided.

For example, lead zirconate titanate is used for the piezoelectric element 4. Alternatively, a material mainly containing a lead-free piezoelectric material such as barium titanate or bismuth sodium titanate may be used. The lead-free material refers to a material containing 1000 ppm or less of lead. Electrode patterns (not illustrated) are formed on both surfaces of the piezoelectric element 4, and power is supplied from the flexible printed circuit board 5. A support member 6 serving as a support member for supporting the vibrator 2, a pressurizing spring 7, and a base 8 that receives a pressure from the pressurizing spring 7 are provided.

As a specific configuration, the support member 6 that pressurizes and supports the vibrator 2 is provided below the vibrator 2 as illustrated in FIG. 1. The pressurizing spring 7 applies a pressure to the support member in the Z-direction, and the base 8 serving as a pressure receiving member receives the reaction force. As the pressurizing spring 7, a conical coil spring is employed to achieve size reduction of the vibration-type actuator 1 in the Z-direction. The coil shape is illustrated in a simplified manner.

The slider 9 serving as the contact member is provided above the vibrator 2 and is in contact with the protruding portions 3a of the elastic member 3. The slider 9 is fixed to a slider holder 10, and the slider 9 and the slider holder 10 are integrally driven in the X-direction relative to the vibrator 2. Rubber to attenuate the vibration may be provided between the slider 9 and the slider holder 10. The slider 9 is made of a metal, ceramics, resin, or a composite material thereof having high wear resistance. In particular, a nitride stainless-steel material such as SUS420J2 is preferable in terms of wear resistance and mass productivity.

Three balls 11 are sandwiched between the slider holder 10 and a ball rail 12 provided with three pairs of upper and lower rails and the ball rail 12 is fixed to the base 8, thereby allowing the slider 9 and the slider holder 10 to move in the X-direction relative to the other components. The slider holder 10 is provided with a power transmission portion with a desired shape to thereby transmit power to the outside. While the present exemplary embodiment illustrates an example where the vibrator 2 is fixed and the slider 9 is configured to be movable, the slider 9 may be fixed and the vibrator 2 may be configured to be movable.

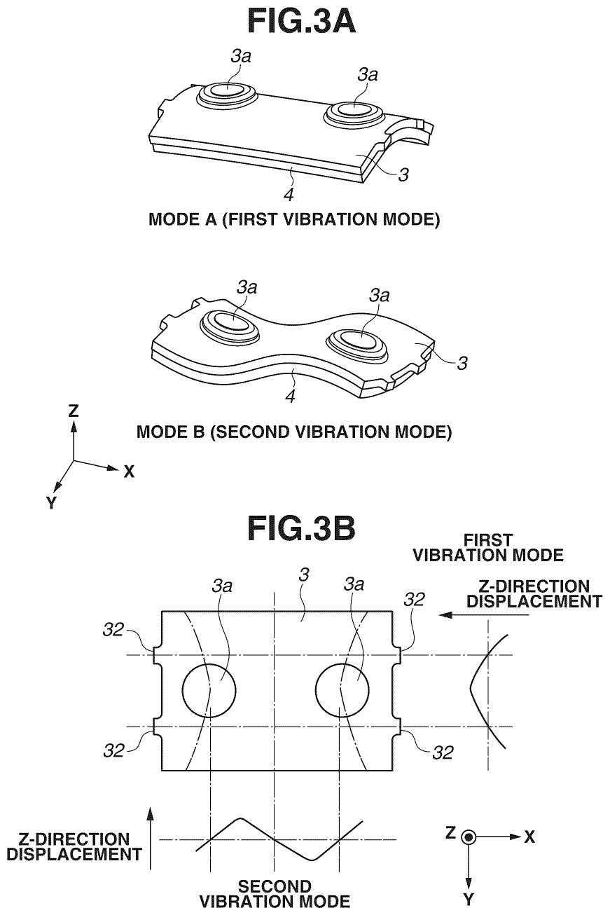

Next, vibration modes excited in the vibrator 2 will be described with reference to FIGS. 3A and 3B. In the present exemplary embodiment, an alternating-current voltage is applied to the piezoelectric element 4 through the flexible printed circuit board 5 to excite two different out-of-plane bending vibrations in the vibrator 2, thereby generating vibration obtained by combining the two different out-of-plane bending vibrations.

A mode A corresponding to a first vibration mode is a primary out-of-plane bending vibration mode in which two nodes appear in parallel to the X-direction that is a longitudinal direction of the vibrator 2. The vibration in the mode A allows the protruding portions 3a located at two positions to be displaced in the Z-direction that is the pressurizing direction. A mode B corresponding to a second vibration mode is a secondary out-of-plane bending vibration mode in which three nodes appear in substantially parallel to the Y-direction that is a transverse direction of the vibrator 2. The vibration in the mode B allows the protruding portions 3a located at two positions to be displaced in the X-direction.

The combination of the vibrations in the mode A and the mode B allows the protruding portions 3a located at two positions to generate an elliptical motion or a circular motion within a ZX-plane. When the slider 9 is brought into pressure contact with these protruding portions 3a, a frictional force is generated in the X-direction and a driving force (thrust force) that causes the vibrator 2 and the slider 9 to relatively move is generated. In the present exemplary embodiment, the vibrator 2 is held by a method to be described below, so that the slider 9 is moved in the X-direction.

To effectively drive the vibration-type actuator 1, it may be desirable to support the vibrator 2 without inhibiting the vibrations (displacements) in the two vibration modes to be excited in the vibrator 2. To achieve this, it may be desirable to support portions in the vicinity of nodes in the two vibration modes. For this reason, the support member 6 is provided with two convex portions 6a as illustrated in FIG. 2 to selectively pressurize and hold nodes that are common to the two vibration modes to be excited in the vibrator 2. FIGS. 3A and 3B illustrate the contact positions and node positions in each vibration mode. Six positions where nodes in the two vibration modes overlap each other appear. When two longitudinal central portions are pressurized, an equalizing function about a Y-axis can be provided and the vibrator 2 and the slider 9 can be brought into contact with each other substantially uniformly.

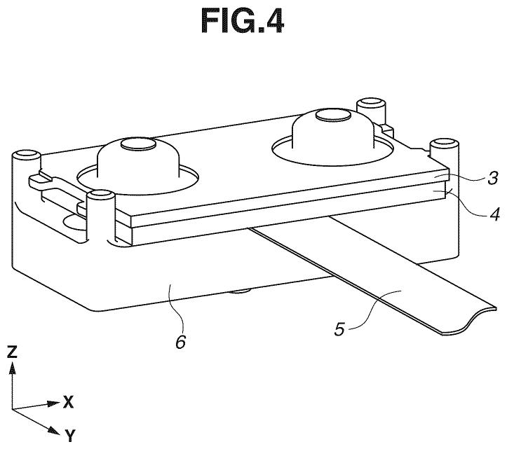

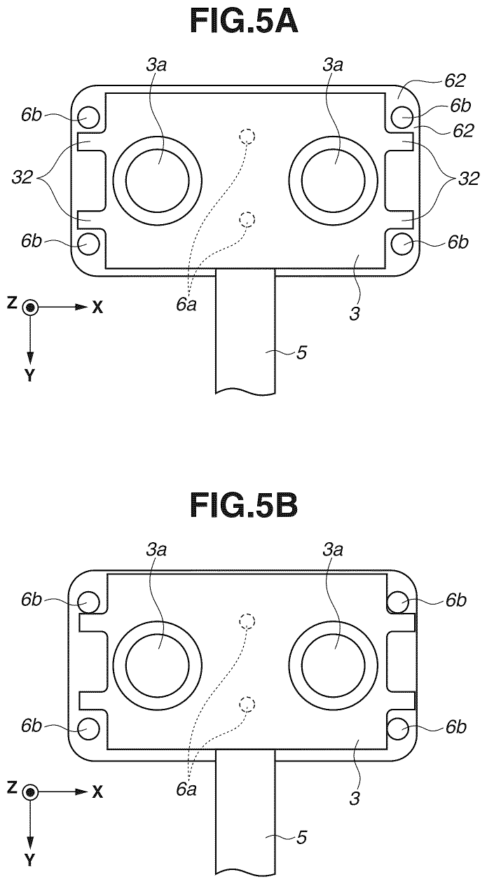

FIG. 4 is an enlarged perspective view illustrating the vibrator and the support member. FIGS. 5A and 5B are plan views thereof. The support member 6 is provided with four loosely fitting portions 62. In each loosely fitting portion 62, a columnar portion 6b is loosely fitted to the corresponding one of four corner portions of the elastic member, thereby supporting the elastic member. Each corner portion serving as a support portion need not necessarily include a vertex of the corresponding one of the four corners of the elastic member.

The support member 6 supports (loosely fits) the elastic member in a state where the support member 6 has a backlash in at least one of the X-direction and the Y-direction with respect to an outer peripheral portion as viewed from a projection on an XY-plane formed of the rectangular plate portion and the extending portion in the vibrator 2. These loosely fitting portions 62 function as stoppers when positioning is performed during assembly of the vibrator 2 or when some external force acts on the slider 9.

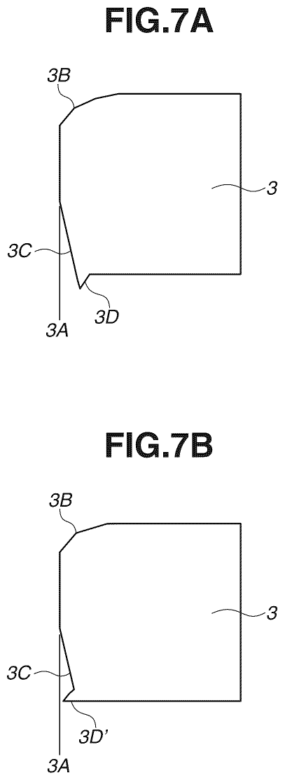

FIG. 5A illustrates a state where the vibrator is located at the center and all extending portions 32 have a backlash with respect to the four columnar portions 6b of the support member 6. FIG. 5B illustrates a state the extending portions 32 are brought into contact with one side by an external force. When the elastic member 3 is formed by press processing, a burr or sagging often occurs at edges of the outer shape due to a punching process. FIGS. 7A and 7B illustrate an XZ-sectional shape as a state of a contact surface between the support member 6 (not illustrated) and the elastic member 3 and an inclined portion. The elastic member 3 is provided with a substantially rectangular plate portion 30 and four extending portions 32 in total, including two extending portions 32 extending from the plate portion 30 in a positive direction of the X-direction and two extending portions 32 extending from the plate portion 30 in a negative direction of the X-direction.

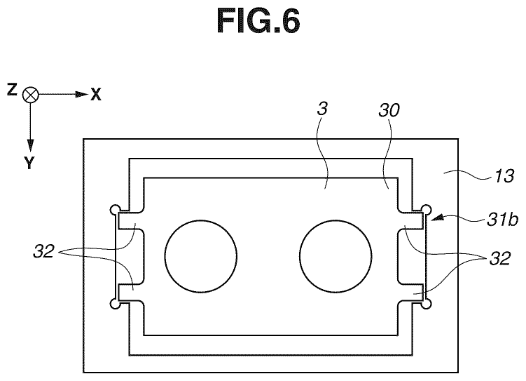

In the present exemplary embodiment, when a punching surface (XY-planar portion in the elastic member 3) and the support member are brought into contact with each other as illustrated in FIG. 5B, it may be desirable to decrease a frictional resistance due to the interference or prevent occurrence of the frictional resistance. For example, if the burr included in the elastic member 3 is crushed and protrudes along an XY-plane portion and the protruding burr gets into the columnar portions 6b of the support member, in particular, the feeding vibration is inhibited and the motor performance deteriorates. Further, when the piezoelectric element is bonded to the elastic member and positioning is performed by a bonding jig 13 as illustrated in FIG. 6, it may be desirable to prevent a tip end face 31b of each extending portion 32 from interfering with the jig due to the protruding burr.

FIG. 7A illustrates a state where a punching burr 3D protrudes downward in the Z-direction on the XZ-section of the elastic member 3. The present exemplary embodiment has such a feature that a fracture surface 3C with a moderate inclination with respect to a sheared surface 3A is provided in a direction away from the support member (not illustrated) below the sheared surface 3A that is a contact surface of the support member (not illustrated) as illustrated in FIG. 7A. The provision of the fracture surface 3C as described above reduces the possibility of causing the burr to protrude from the sheared surface 3A even when the burr 3D is deformed after polishing processing or the like is performed on the bottom surface of the elastic member 3 and a burr 3D′ of the elastic member 3 protrudes leftward as illustrated in FIG. 7B.

It may be desirable to prevent the burr 3D′ that is crushed after another process from protruding toward the left side of the sheared surface 3A, or to minimize the amount of protrusion. Accordingly, the fracture surface 3C below the sheared surface 3A may desirably have a moderate inclination. This inclination is adjusted based on the amount of clearance of a mold die and a punch. The inclination increases as the amount of clearance increases. At the same time, a sagging 3B also increases. There is no problem if each extending portion 32 has the large sagging 3B. However, if the rectangular portion used for bonding the piezoelectric element has such a large sagging, the sagging may remain even after the bonding surface is polished, which may have an adverse effect on the bonding strength. For this reason, it may be desirable to reduce the sagging 3B at the ridge of the bonding surface and prevent the burr 3D′ from protruding from the sheared surface 3A. Since the tip end face 31b of each extending portion 32 is not a bonding surface, the inclination of the section may be increased by increasing the amount of clearance. An increase in the amount of clearance at the extending portions 32 excluding the tip end face 31b leads to an imbalance in punching processing. Accordingly, the amount of clearance is determined in consideration of the sagging 3B at the ridge of the bonding surface.

As described above, according to the present disclosure, it is possible to provide a compact vibration-type actuator capable of performing a stable driving operation with a smaller number of components as compared with the related art.

In the linear vibration-type actuator according to the present disclosure, the method of generating an elliptical motion or a circular motion on the contact surface is not limited to the above-described method. For example, vibrations in bending vibration modes different from the above-described vibration modes may be combined.

Alternatively, vibration in a longitudinal vibration mode in which the elastic member is stretched in the longitudinal direction and vibration in a bending vibration mode may be combined.

Any driving method may be used as long as the method can generate an elliptical motion and a circular motion on a contact surface by a combination of a vibration mode in which the contact surface is displaced in a movement direction of a driven member and a vibration mode in which the contact surface is displaced in the pressurizing direction, and the vibration modes include common nodes for pressurization and holding.

Further, a configuration in which the slider is sandwiched between two vibrators so as to improve the thrust force may be employed.

### Second Exemplary Embodiment

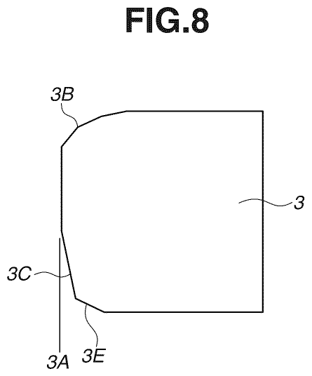

The second exemplary embodiment will be described with reference to FIG. 8. The elastic member illustrated in FIG. 8 include, as the above-described inclined portion, inclined portions having different inclination angles or different curvatures, are inclined in a direction away from the support member and located adjacent to each other.

As an example of a method for manufacturing the elastic member illustrated in FIG. 8, a burr crushing process is added to the punching process for the elastic member 3 in the vibration-type actuator according to the first exemplary embodiment of the present disclosure. A side surface formed after the burr crushing process has a sectional shape that forms an inclined surface 3E due to crushing of the burr 3D. In other words, the first fracture surface 3C and the second inclined surface 3E are formed. The burr crushing process causes a plastic flow of the burr 3D toward the sheared surface 3C. However, a sharp burr can be eliminated and adverse effects on the motor performance can be further avoided.

Similarly, a configuration in which a sagging portion formed of the sagging 3B as illustrated in FIG. 8 is provided and another sagging portion adjacent to the contact surface is further provided on an opposite side of the inclined portion with respect to the contact surface may be employed, as a matter of course.

In this case, it may be desirable to employ a configuration in which the electro-mechanical energy conversion element is provided on the surface of the plate portion of the elastic member on a side closer to the sagging portion than the inclined portion.

### Third Exemplary Embodiment

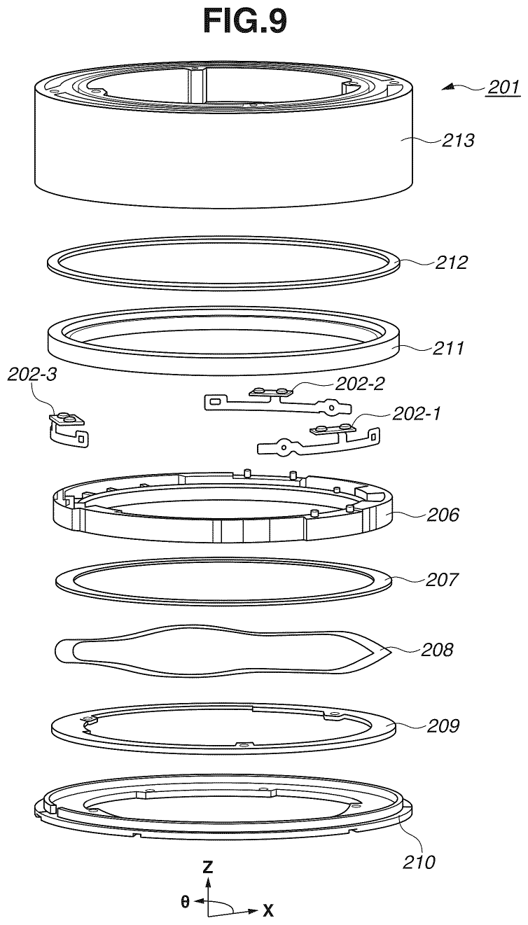

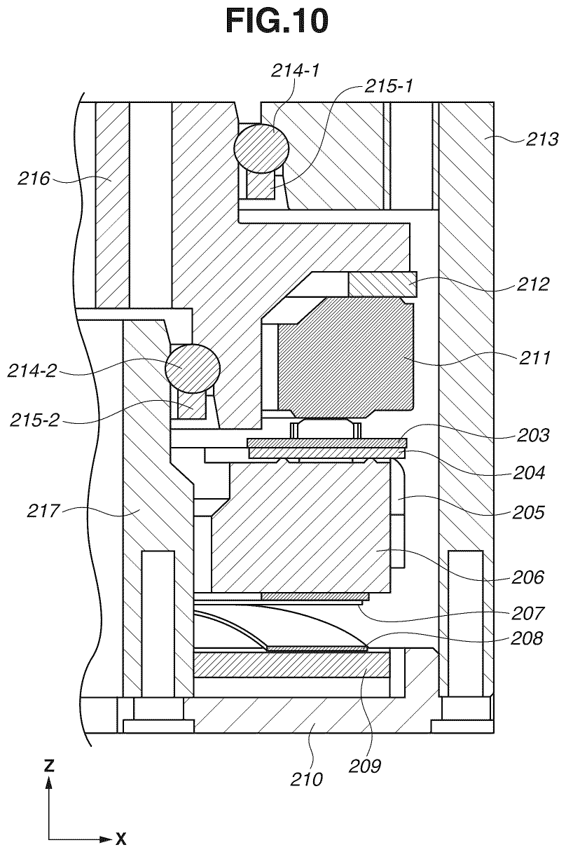

The third exemplary embodiment will be described with reference to FIGS. 9 and 10. FIG. 9 is an exploded perspective view of a vibration-type actuator according to the third exemplary embodiment of the present disclosure. A radial direction is defined as the X-direction, a rotational direction is defined as a θ-direction, and a pressurizing direction is defined as the Z-direction. FIG. 10 is a ZX-sectional view of the vibration-type actuator according to the third exemplary embodiment of the present disclosure.

The present exemplary embodiment has a feature that three vibrators 202 (202-1, 202-2, 202-3) are held by a ring base 206. The configuration of each vibrator 202 and the driving principle are similar to those of the first or second exemplary embodiment, and thus description thereof is omitted.

Three sets of convex portions and loosely fitting portions, which have similar functions as those of the first or second exemplary embodiment, are provided on the ring base 206 every 120 degrees, and hold and loosely fit the vibrators 202, respectively. Flexible printed circuit boards of the vibrators 202 are connected by a connecting flexible printed circuit board (not illustrated), and the same driving voltage is applied to each piezoelectric element.

A rotor 211 serving as a driven member is brought into contact with protruding portions of each vibrator 202, and the rotor 211 is rotated by a driving force generated in a tangential direction. An upper portion of the rotor 211 is provided with a vibration-proof rubber 212, and each component is held integrally with a power transmission member 216 in a rotatable state.

On the other hand, the ring base 206 having an annular shape is combined with an inner cylinder 217 at a portion (not illustrated), thereby regulating movements in the central axis direction and the radial direction and the rotation about the central axis.

A lower portion of the ring base 206 is provided with a pressurizing auxiliary member 207 having a predetermined rigidity, which makes a pressure generated by a wave washer 208, which is a support member, uniform. A pressure receiving member 209 is located below the wave washer 208.

This pressure receiving member 209 engages with the inner cylinder 217 with a screw or a bayonet structure on the inner diameter side thereof. A vibration-type actuator 201 rotates the pressure receiving member 209 to move in the central axis direction, thereby compressing the wave washer 208. The components ranging from the ring base 206 to the power transmission member 216 are pressurized and sandwiched between an outer cylinder 213 and the inner cylinder 217 and the pressure receiving member 209. Balls 214 and retainers 215 are provided between the outer cylinder 213 and the inner cylinder 217 and the power transmission member 216, and rotatably support the power transmission member 216 while receiving the pressure. The outer cylinder 213 and the inner cylinder 217 are connected together by screwing a lid 210.

Also, in the present exemplary embodiment, the convex portions and the loosely fitting portions on the ring base 206 provide the equalizing function about the X-axis, thereby simplifying the configuration for supporting the vibrators 202.

While the present exemplary embodiment described above illustrates an example where the three vibrators 202 are provided, the present exemplary embodiment is not limited to this example. Any number of vibrators 202 may be provided as long as at least one vibrator 202 can be provided on the ring base 6.

### Fourth Exemplary Embodiment

The present disclosure can provide an electronic apparatus including any one of the above-described vibration-type actuators and a member to be driven by the vibration-type actuator.

The vibration-type actuator can be used for, for example, driving a lens of an image capturing apparatus (optical apparatus). Specifically, an optical apparatus including the vibration-type actuator and an optical element to be driven by the vibration-type actuator can be provided.

Accordingly, for example, an image capturing apparatus using a rotational vibration-type actuator according to the third exemplary embodiment to drive a lens as an optical element located within a lens barrel will be described.

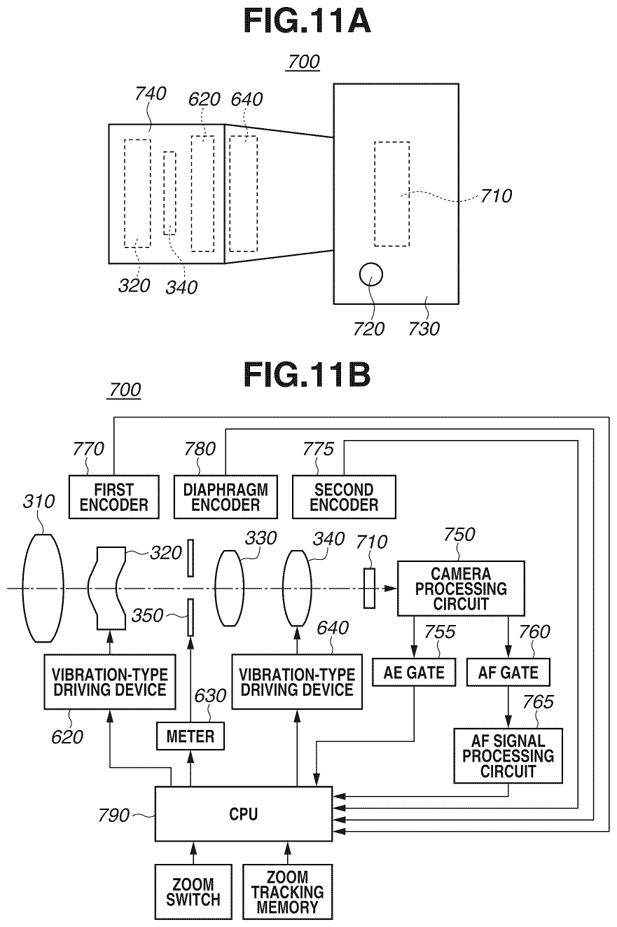

FIG. 11A is a top view illustrating a schematic configuration of an image capturing apparatus 700. The image capturing apparatus 700 includes a camera body 730 including an image sensor 710 and a power button 720. The image capturing apparatus 700 further includes a lens barrel 740 including a first lens group (not illustrated), a second lens group 320, a third lens group (not illustrated), a fourth lens group 340, and vibration-type driving devices 620 and 640. The lens barrel 740 can be replaced as an interchangeable lens. The lens barrel 740 that is suitable for an image capturing target can be attached to the camera body 730. In the image capturing apparatus 700, the two vibration-type driving devices 620 and 640 drive the second lens group 320 and the fourth lens group 340, respectively.

Although the detailed configuration of the vibration-type driving device 620 is not illustrated, the vibration-type driving device 620 includes a vibration-type actuator and a driving circuit for the vibration-type actuator. The rotor 211 is located within the lens barrel 740 such that the radial direction is substantially orthogonal to the optical axis. In the vibration-type driving device 620, the rotor 211 is rotated about the optical axis and a rotation output from the driven member is converted into a translatory movement in the optical axis direction via a gear or the like (not illustrated), thereby moving the second lens group 320 in the optical axis direction. The vibration-type driving device 640 has a configuration similar to that of the vibration-type driving device 620, thereby moving the fourth lens group 340 in the optical axis direction.

FIG. 11B is a block diagram illustrating a schematic configuration of the image capturing apparatus 700. A first lens group 310, a second lens group 320, a third lens group 330, a fourth lens group 340, and a light amount adjustment unit 350 are located at predetermined positions on an optical axis within the lens barrel 740. Light that has passed through the first to fourth lens groups 310 to 340 and the light amount adjustment unit 350 is focused on the image sensor 710. The image sensor 710 converts an optical image into an electric signal and outputs the electric signal. The output electric signal is transmitted to a camera processing circuit 750.

The camera processing circuit 750 performs amplification, gamma correction, and the like on the output signal from the image sensor 710. The camera processing circuit 750 is connected to a central processing unit (CPU) 790 via an AE gate 755, and is also connected to the CPU 790 via an AF gate 760 and an AF signal processing circuit 765. A video signal subjected to predetermined processing in the camera processing circuit 750 is transmitted to the CPU 790 through the AE gate 755, the AF gate 760, and the AF signal processing circuit 765. The AF signal processing circuit 765 extracts high-frequency components from the video signal to generate an evaluation value signal for auto focus (AF), and supplies the generated evaluation value signal to the CPU 790.

The CPU 790 is a control circuit that controls an overall operation of the image capturing apparatus 700, and generates control signals for exposure determination and focusing based on the obtained video signal. The CPU 790 controls driving of the vibration-type driving devices 620 and 640 and a meter 630 so as to obtain a determined exposure state and an appropriate focus state, thereby adjusting the positions of the second lens group 320, the fourth lens group 340, and the light amount adjustment unit 350 in the optical axis direction. Under the control of the CPU 790, the vibration-type driving device 620 causes the second lens group 320 to move in the optical axis direction, the vibration-type driving device 640 causes the fourth lens group 340 to move in the optical axis direction, and driving of the light amount adjustment unit 350 is controlled by the meter 630.

The position of the second lens group 320 in the optical axis direction to be driven by the vibration-type driving device 620 is detected by a first linear encoder 770. A notification about the detection result is transmitted to the CPU 790, thereby feeding back the detection result in driving of the vibration-type driving device 620. Similarly, the position of the fourth lens group 340 in the optical axis direction to be driven by the vibration-type driving device 640 is detected by a second linear encoder 775, and a notification about the detection result is transmitted to the CPU 790, thereby feeding back the detection result in driving of the vibration-type driving device 640. The position of the light amount adjustment unit 350 in the optical axis direction is detected by a diaphragm encoder 780, and a notification about the detection result is transmitted to the CPU 790, thereby feeding back the detection result in driving of the meter 630.

The configuration of the electronic apparatus including members and any one of the vibration-type actuators described above to drive the members makes it possible to provide a more compact electronic apparatus.

### Fifth Exemplary Embodiment

In the fifth exemplary embodiment, an example of manufacturing the elastic member 3 by press molding will be described with reference to the drawings.

The configuration of the vibration-type actuator 1 is similar to that illustrated in FIGS. 1 and 2 and is described in detail in the first exemplary embodiment. Accordingly, the description thereof is omitted in the present exemplary embodiment.

The protruding portions 3a provided on the elastic member 3 are also described in the first exemplary embodiment, and thus description thereof is omitted.

In the present exemplary embodiment, a contour portion of the elastic member 3 is formed by shearing processing in press molding as described above in the first exemplary embodiment.

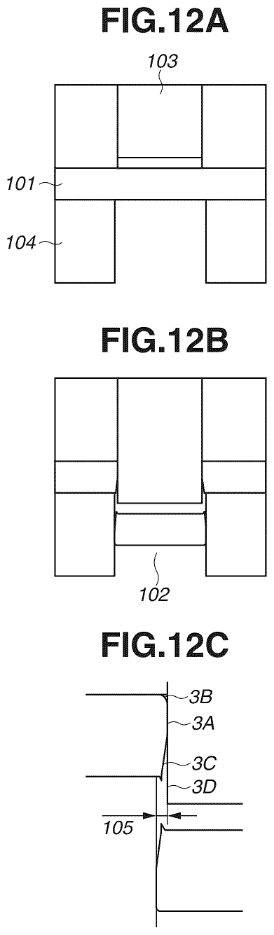

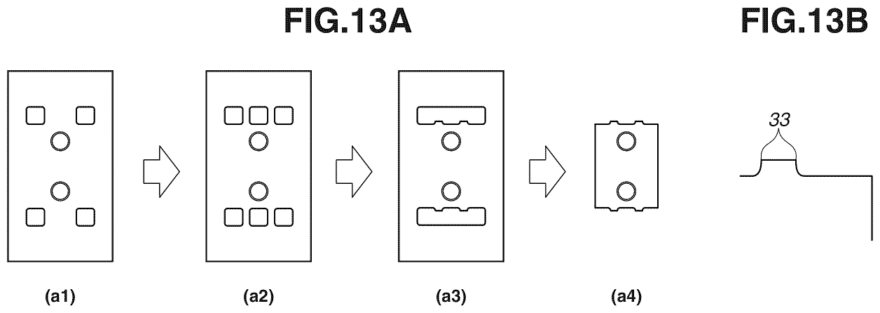

FIGS. 12A to 12C are schematic diagrams each illustrating shearing processing in press molding. FIGS. 13A and 13B are process diagrams each illustrating a process of trimming the rectangular portion and the extending portion of the elastic member from a plate.

A scrap 102 of a processed material 101 set in a press mold as illustrated in FIG. 12A is cut off by a punch 103 that descends as illustrated in FIG. 12B. FIG. 12C illustrates an enlarged view of a shearing portion at this time. The processed material 101 forms the sagging 3B, the sheared surface 3A, the fracture surface 3C, and the burr 3D, and the amount of each component is determined by an amount of clearance (gap) 105 between the punch 103 and the die 104. In general, the width of the sagging 3B, the area of the sheared surface 3A, the inclination angle of the fracture surface 3C, and the height of the burr 3D increase as the clearance 105 is widened, while the width of the sagging 3B, the area of the sheared surface 3A, the inclination angle of the fracture surface 3C, and the height of the burr 3D decrease as the clearance 105 is narrowed.

In the case of forming the contour portion of the elastic member 3 by general shearing processing as described above, the contour portion may be formed at once by performing shearing processing once, or the contour portion may be formed step by step in a plurality of steps. The elastic member 3 according to the present exemplary embodiment is provided with a corner portion 33 at the tip end face 31b of the extending portion 32 as illustrated in FIG. 13B so as to reduce the size of the vibration-type actuator. If the elastic member has such a corner portion, the contour portion is generally formed through a plurality of steps so as to reduce damage to mold components. Accordingly, also in the present exemplary embodiment, the contour portion is formed through a plurality of steps (a1) to (a4) illustrated in FIG. 13A.

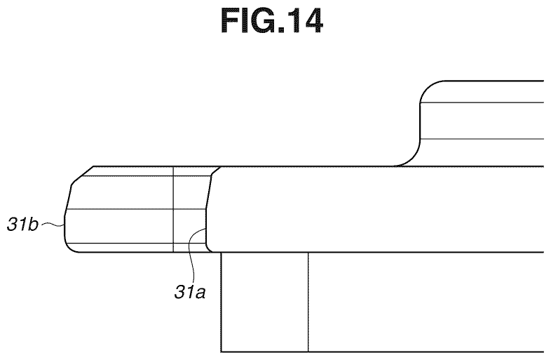

The formation through a plurality of steps makes it possible to reduce the amount of the clearance 105 to form the rectangular portion (rectangular portion side surface 31a) of the elastic member 3, and to increase the amount of the clearance 105 to form the extending portion tip end face (extending portion tip end face 31b) of the elastic member as illustrated in FIG. 14. Setting values can also be changed depending on locations, and the shape of the contour portion can be determined depending on the intended use.

However, the formation through a plurality of steps may cause the phenomenon (3D′) in which the elastic member 3 is strongly pressed in other processes within the mold and the burr 3D is crushed. This phenomenon occurs not only in a progressive mold in which a plurality of processes is provided for each mold, but also in a single mold in which only one process is provided.

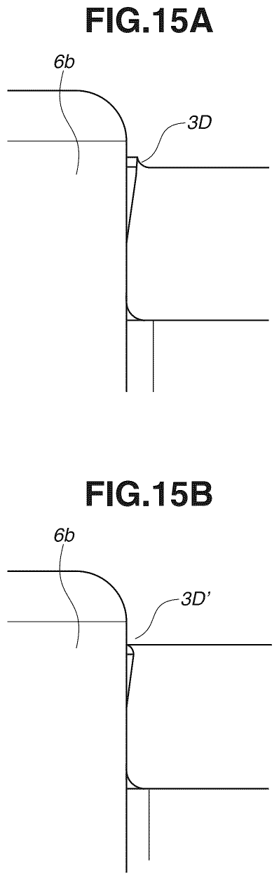

FIGS. 15A and 15B each illustrate a state where the burr is crushed. If the leading edge of the burr such as the burr 3D′ extends in the direction of the columnar portion 6b of the support member 6 that loosely fits the elastic member 3, an incisive interference between the burr 3D′ and the columnar portion 6b occurs, which may inhibit the vibration of the elastic member 3. The sheared surface 3A is in contact with the elastic member 3 and the columnar portion 6b. Accordingly, if the clearance 105 is set to, for example, the amount at which the larger fracture surface 3C can be secured during shearing processing, the leading edge of the crushed burr does not protrude from the sheared surface 3A and the crushed burr does not inhibit the vibration.

On the other hand, if the bonding surface between the elastic member 3 and the piezoelectric element 4 is formed with a wider area, energy can be effectively transmitted. Accordingly, it may be desirable to accurately finish the flat surface of the bonding surface on the side of the elastic member 3 by a polishing process or the like. In general, in the case of finishing the flat surface by a polishing process, if the polishing processing surface has the burr 3D (3D′), it is difficult to accurately finish the flat surface. Therefore, it is preferable to finish the sagging surface by polishing. If the amount of the clearance 105 is set to a larger value, the amount of the sagging 3B increases, so that a unpolished portion is likely to be generated. Accordingly, it is not preferable to increase the amount of the clearance 105 for the rectangular portion on the bonding surface as a method for preventing the burr 3D′ from protruding from the sheared surface 3A.

On the other hand, the tip end face 31b of the extending portion 32 is not a bonding surface to be bonded to the piezoelectric element 4. Accordingly, the above-described countermeasures may be taken so that the tip end face 31b can be used for another application in other processes, for example, positioning during bonding between the elastic member 3 and the piezoelectric element 4.

In the present exemplary embodiment, the inclined surface is formed by burr crushing processing in press molding on the burr portion of the elastic member 3 on the contact surface between the elastic member 3 and the columnar portion 6b, thereby avoiding an incisive interference between the elastic member 3 and the columnar portion 6b.

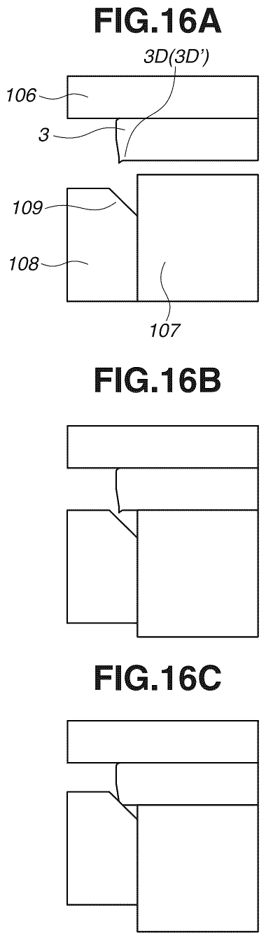

FIGS. 16A to 16C are schematic diagrams each illustrating burr crushing processing. An example of forming an inclined surface with respect to the burr 3D (3D′) will be described. FIG. 16A illustrates a top dead center state in press molding. FIG. 16B illustrates a halfway state of the processing. FIG. 16C illustrates a bottom dead center state.

The elastic member 3 including the burr 3D (3D′) is pressed down by a descending die 106 and contacts a material presser 107 that is caused to slide up and down by a coil spring or the like. The elastic member 3 that is narrowed and pressed between the material presser 107 and the die 106 as illustrated in FIG. 16B further descends by following the die 106 that continuously descends. Then, the burr 3D (3D′) is pressed against a taper 109 provided on the punch 108 as illustrated in FIG. 16C and the inclination of the taper 109 is transferred, thereby forming the inclined surface 3E.

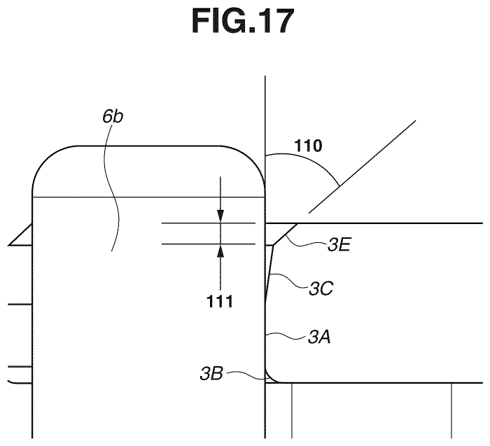

FIG. 17 is an enlarged view illustrating a state where the elastic member 3 having the inclined surface 3E and the columnar portion 6b are brought into contact with each other.

The inclined surface 3E is inclined in a direction away from the support member 6 from a halfway position of the fracture surface 3C that is continuous to the sheared surface 3A and in a direction toward the slider 9. Since the formation of the inclined surface 3E causes a plastic flow of the burr 3D (3D′) toward the sheared surface 3A, there is a need to set the burr crushing amount within a range of a space generated between the fracture surface 3C and the columnar portion 6b. In the present exemplary embodiment, an inclination angle 110 is set to 45 degrees and an inclination depth 111 is set to be less than or equal to 0.05 mm for the elastic member with a plate thickness of 0.3 mm.

For example, if the clearance 105 illustrated in FIG. 12C is narrower than an appropriate value, two independent sheared surfaces may be generated within a single shearing processing surface. This is called secondary shearing.

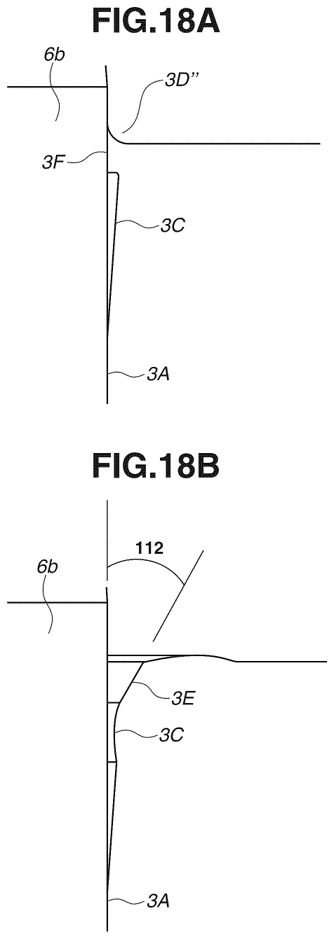

FIG. 18A illustrates a state where the punching processing surface of the elastic member 3 is subjected to secondary shearing. A secondary shearing surface 3F is flush with the sheared surface 3A, and a burr 3D″ on the secondary shearing surface 3F is present at a location closer to the support member 6 than the burr 3D. For the burr 3D″, for example, the inclination angle 112 is set to be less than or equal to 45 degrees as illustrated in FIG. 18B, thereby making it possible to generate an active plastic flow in a direction opposite to the columnar portion 6b.

The present disclosure can be suitably applied to an optical apparatus such as a camera, or various electronic apparatuses.

The present disclosure is not limited to the above embodiments, and various changes and modifications can be made without departing from the spirit and scope of the present disclosure. Therefore, the following claims are attached to publicly disclose the scope of the present disclosure.

According to the present disclosure, it is possible to provide a small vibration-type actuator capable of performing a driving operation at a stable speed.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

1. A vibration-type actuator comprising:
a vibrator including an electro-mechanical energy conversion element and an elastic member; and
a contact member to be bought into contact with the elastic member, vibration of the vibrator allowing the contact member and the vibrator to relatively move in a first direction,
wherein the elastic member includes a rectangular plate portion along the first direction, a protruding portion protruding in a second direction crossing the first direction, and an extending portion extending from the plate portion in a direction along the first direction,
wherein the vibration-type actuator further comprises a support member to be brought into contact with at least one of the extending portion and the plate portion to support the vibrator movably along the second direction, and
wherein a part of the elastic member is provided with a contact surface and an inclined portion, the contact surface being in contact with the support member along the second direction, the inclined portion being adjacent to the contact surface and being inclined in a direction away from the support member relative to the contact surface.

2. The vibration-type actuator according to claim 1, wherein the support member includes a convex portion to selectively support a node common to two different vibration modes in the vibrator.

3. The vibration-type actuator according to claim 1, wherein a columnar portion provided on the support member contacts at least one of the extending portion and the plate portion of the elastic member.

4. The vibration-type actuator according to claim 3, wherein a plurality of the columnar portions supports the elastic member by loosely fitting four corner portions of the elastic member.

5. The vibration-type actuator according to claim 1, wherein the inclined portion includes inclined portions having different inclination angles or different curvatures, the inclined portions being inclined in a direction away from the support member and being adjacent to each other.

6. The vibration-type actuator according to claim 1, further comprising a sagging portion on an opposite side of the inclined portion with respect to the contact surface, the sagging portion being adjacent to the contact surface.

7. The vibration-type actuator according to claim 6, wherein the electro-mechanical energy conversion element is located on a surface of the plate portion that is closer to the sagging portion than the inclined portion.

8. An electronic apparatus comprising:
the vibration-type actuator according to claim 1; and
a member to be driven by the vibration-type actuator.

9. An optical apparatus comprising:
the vibration-type actuator according to claim 1; and
an optical element to be driven by the vibration-type actuator.
